(19) United States
(12) Patent Application Publication
(10) Pub. No.: US 2006/0067487 A1
(43) Pub. Date: Mar. 30, 2006

(54) System for announcing electronic messages

(76) Inventor: Yip W. Ho, Hong Kong (CN)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/237,016

(22) Filed: Sep. 28, 2005

Related U.S. Application Data
(60) Provisional application No. 60/614,392, filed on Sep. 29, 2004.

(51) Int. Cl. H04M 1/64

(52) U.S. Cl. 379/88.12

(57) ABSTRACT

A system for visually and/or audibly announcing electronic messages, such as email messages, text messages and instant messages is described.

### CROSS-REFERENCE TO RELATED APPLICATIONS

This application claims priority of U.S. provisional patent application Ser. No. 60/614,392, filed Sep. 29, 2004.

### FEDERALLY SPONSORED RESEARCH OR DEVELOPMENT

Not Applicable.

### TECHNICAL FIELD

The present invention relates to a device for audibly and visually announcing receipt of an electronic message, such as an email message, a text message or an instant message.

### BACKGROUND OF THE INVENTION

Electronic messages have become a very common form of communication. Often when such a message is sent, the sender of the message assumes the receiver of the message will immediately see, and respond to, the message. While this might be the case if the receiver of the message is attentive at his/her computer, this might not be the case if the receiver of the message is otherwise distracted.

### BRIEF DESCRIPTION OF THE DRAWINGS

FIG. 1 is a perspective drawing of a system for announcing electronic messages according to the present invention.

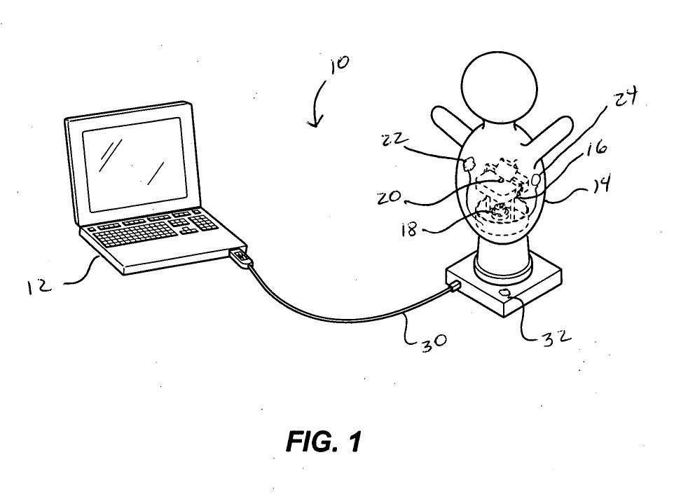

FIG. 2 is a perspective view of control circuitry and an actuator for the system of FIG. 1.

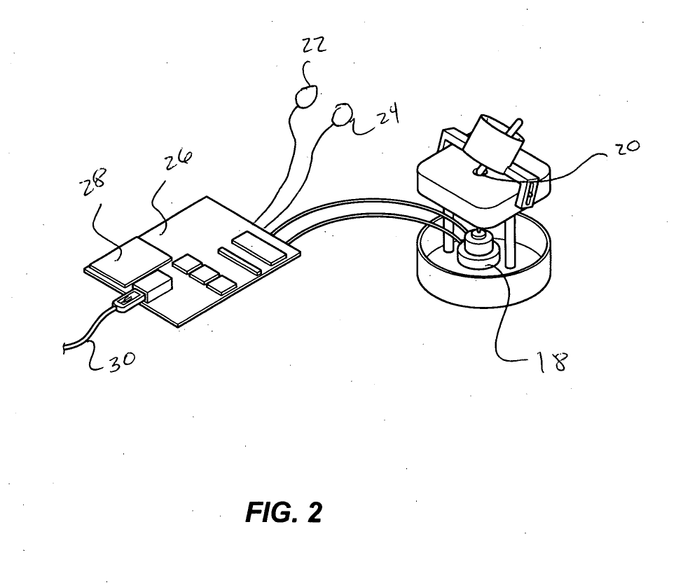

While this invention is susceptible of embodiments in many different forms, there is shown in the drawings and will herein be described in detail, preferred embodiments of the invention with the understanding that the present disclosure is to be considered as an exemplification of the principles of the invention and is not intended to limit the broad aspect of the invention to the embodiments illustrated.

A system 10 for announcing electronic messages, such as an email message, a text message or an instant message, is illustrated in the Figures. The system 10 includes a communication device, such as a conventional personal computer 12, having access to the internet for receiving electronic messages. Alternatively, the communication device could be a cellular telephone (not shown) or such other device which can receive electronic messages.

The system 10 further includes an animated device 14. As discussed in greater detail below, the animated device 14 includes one or more indicating devices for indicating reception of an electronic message. The indicating device may be an actuator 16 for causing movement of the animated device 14. The actuator 16 can be a simple rotary motor 18 with a conventional eccentric geared connection 20 for making reciprocal motion, or it could be more complex. The indicating device may be a speaker 22 for creating sound. The indicating device may be a light 24.

The animated device 14 further includes control circuitry 26 for driving the particular indicating devices. The control circuitry 26 includes a conventional microprocessor 28 having memory. The microprocessor 28 has an 8 bit output and can control up to 256 different indicating devices.

The computer 12 is communicatively coupled to the control circuitry 26, such as by a conventional USB cable 30. Alternative connections, such as wireless (not shown), could also be used to connect the computer 12 to the animated device 14.

When the computer 12 receives an electronic message, the computer 12 sends a message signal to the control circuitry 26 indicating receipt of the electronic message. Software, such as conventional email arrival detection software, causes the computer 12 to generate the message signal via a conventional USB port of the computer 12.

In a first embodiment, the microprocessor memory has been preprogrammed to include files for controlling the particular indicating devices. The file may be an audio file, such as a repeating three-second .wav file, to be output via the speaker 22. The file may be an actuation file, to control the actuator 16 or the light 24. Software permits the preprogramming of the audio and actuation files.

When the control circuitry 26 receives the message signal, the audio file is played through the speaker 22, audibly announcing the arrival of the electronic message. Simultaneously, the actuation file actuates the actuator 16 and/or light 24 in a preprogrammed manner, visually announcing the arrival of the electronic message.

In an alternative embodiment, sender specific audio files and actuation files are stored for specific electronic message senders, or groups of senders. Thus, receipt of a message from a particular sender, or group of senders, results in a unique audible and actuation response. Preprogrammed generic audio and actuation files would be stored for use when a message is received from a sender not having its own, specific preprogrammed audio and actuation files.

The audio and animation would continue for a period of time, the length of which is stored on the control circuitry 26. Additionally, the animated device 14 includes a mute button 32, which would stop both the audio as well as the animation.

Additional features, as well, are contemplated. For example, the electronic message may be in the form of weather updates received by the computer 12 over the internet. A weather forecast would be played over the speaker 22, and an appropriate animation could be performed. Similarly, the received over the internet and which could be played and animated.

While specific embodiments have been illustrated and described, numerous modifications may come to mind Without significantly departing from the spirit of the invention, and the scope of protection is only limited by the scope of the accompanying claims.

What is claimed is:

1. A system for announcing receipt of electronic messages, the system comprising:
a communication device for receiving the electronic messages;
an animated device; and
circuitry coupled to the communication device and the animated device for causing the animated device to announce receipt of the electronic message.

2. The system of claim 1 wherein the animated device moves to visually announce receipt of the electronic message.

3. The system of claim 1 wherein the animated device creates an audible sound to audibly announce receipt of the electronic message.

4. The system of claim 1 wherein the announcement is specific to certain senders of the electronic message.

5. The system of claim 1 wherein the communication device comprises a personal computer.

6. The system of claim 1 wherein the communication device comprises a cellular telephone.

7. The system of claim 1 wherein the electronic messages comprise e-mail messages.

8. The system of claim 1 wherein the electronic messages comprise text messages.

9. The system of claim 1 wherein the electronic messages comprise instant messages.

10. The system of claim 1 wherein the circuitry is substantially disposed in the animated device.

11. The system of claim 1 wherein the circuitry includes a microprocessor.

12. The system of claim 1 wherein the circuitry is coupled to the communication device by a USB connection.

13. A system for announcing receipt of electronic messages, the system comprising:
a personal computer for receiving the electronic messages;
an animated device having apparatus for causing animated motion of the animated device; and
microprocessor based circuitry for activating the animated device upon receipt of a message.

14. The system of claim 13 wherein the microprocessor based circuitry is substantially disposed in the animated device.

15. The system of claim 13 wherein the microprocessor based circuitry is substantially disposed in the personal computer.

16. The system of claim 13 wherein the animated device moves to visually announce receipt of the electronic messages.

17. The system of claim 13 wherein the animated device creates an audible sound to audibly announce receipt of the electronic messages.

18. The system of claim 13 wherein the announcement is specific to certain senders of the electronic message.

19. The system of claim 13 wherein the electronic messages comprise e-mail messages.

20. The system of claim 13 wherein the electronic messages comprise text messages.

21. The system of claim 13 wherein the electronic messages comprise instant messages.
